(19) United States
(12) Patent Application Publication
(10) Pub. No.: US 2006/0129367 A1
(43) Pub. Date: Jun. 15, 2006

(54) Systems, methods, and computer program products for system online availability estimation

(75) Inventors: Kesari Mishra, Santa Clara, CA (US); Kishor Trivedi, Durham, NC (US)

Correspondence Address: JENKINS, WILSON & TAYLOR, P. A., 3100 TOWER BLVD, SUITE 1200, DURHAM, NC, 27707, US

(73) Assignee: Duke University

(21) Appl. No.: 10/984,576

(22) Filed: Nov. 9, 2004

(51) Int. Cl. G06F 17/50

(52) U.S. Cl. 703/13

(57) ABSTRACT

Systems, methods, and computer program products for system online availability estimation. A method according to one embodiment can include a step for providing an availability model of a system. The method can also include a step for receiving behavior data of the system. In addition, the method can include estimating a plurality of parameters for the availability model based on the behavior data. The method can also include determining individual confidence intervals for each of the parameters. Further, the method can include determining an overall confidence interval for the system based on the individual distributions of the estimated parameters. The method can also include determining control actions based on the estimated overall availability or inferred parameter values.

### GRANT STATEMENT

This invention was supported by U.S. Army Research Office Federal Grant No. C-DAAD19 01-1-0646. Thus, the Government has certain rights in this invention.

### TECHNICAL FIELD

The subject matter disclosed herein relates generally to system monitoring. Specifically, the subject matter disclosed herein relates to systems, methods, and computer program products for online system availability estimation.

### BACKGROUND ART

There is a growing reliance upon computers for making systems having critical application more manageable and controllable. However, this reliance has imposed stricter requirements on the dependability of these computers and systems. In critical applications, losses due to system downtime can range from huge financial loss to risk to human life. In safety-critical and military applications, the dependability requirements are even higher as system unavailability would most often result in disastrous consequences. For example, in the case of air traffic control systems, such as Eurocontrol, typical requirements of the enroute subsystem associated with radar data reception, processing and display, specify that these services should not be unavailable for more than three seconds per year. In complex military applications, such as missile tracking systems, surveillance and early warning systems, the unavailability of any component in the system, in combat situations, may have disastrous effect.

Another critical application includes the infrastructure field. In this field, there has been an increase in the interdependence between different critical infrastructures (e.g., communication, power, and the Internet). As a result, a downtime on any of the critical infrastructure can cascade into failure of other infrastructures as well. In the field of electric power generation and distribution, increasing complexity in management and control of electric grid is causing it to transform into an electronically controlled network. Since all other infrastructures are dependent on power, system unavailability in this case can have a far more damaging impact.

Yet another critical application includes business-critical application. Examples of business-critical applications include online brokerages, online shops, and credit card authorizations. In these applications, a system downtime may translate into financial loss due to lost transactions in the short term and a loss of customer base in the long term.

These concerns make it important to ensure the high availability of systems in critical applications to ensure high availability. Availability can be assured by constant evaluation, monitoring, and management of the system. Accordingly, there exists a need for improved systems, methods, and computer program products for system availability estimation. In addition, there is a need for improved systems, methods, and computer program products for taking appropriate control actions to maintain a high level of system availability.

### SUMMARY

Online availability estimators, methods, and computer program products are disclosed for estimating availability of a system. A method according to one embodiment can include a step for providing an availability model of a system. The method can also include a step for receiving behavior data of the system. In addition, the method can include estimating a plurality of parameters for the availability model based on the behavior data. The method can also include determining individual confidence intervals for each of the parameters. Further, the method can include determining an overall confidence interval for the system based on individual distributions of the estimated parameters. According to one embodiment, all of the estimations are carried out in real-time. In addition, the availability model of the system according to one embodiment can be constructed off line. The method can also suggest appropriate control actions to maximize system availability.

Some of the objects having been stated hereinabove, and which are achieved in whole or in part by the present subject matter, other objects will become evident as the description proceeds when taken in connection with the accompanying drawings as best described hereinbelow.

### BRIEF DESCRIPTION OF THE DRAWINGS

Exemplary embodiments of the subject matter will now be explained with reference to the accompanying drawings, of which:

FIG. 1 is a schematic diagram of an online availability estimator according to one embodiment;

FIGS. 2A-2C are three different exemplary reliability block diagrams representing different embodiments of the system shown, for example, in FIG. 1;

FIG. 3 is a schematic diagram of an exemplary CTMC for representing an Internet gateway according to one embodiment;

FIG. 4 is a schematic diagram of another exemplary online availability estimator according to one embodiment;

FIG. 5 is a flow chart illustrating an exemplary process for online availability estimation and control of a system;

FIG. 6 is a schematic diagram of a transaction processing system, which is made reference to for illustrative purposes with respect to FIG. 5; and

FIG. 7 is a schematic diagram of an exemplary availability model for the system shown in FIG. 6.

### DETAILED DESCRIPTION OF THE INVENTION

Methods, systems, and computer program products are disclosed herein for online availability estimation of a system. According to one embodiment, an availability model of a system is provided. Behavior data of a plurality of sub-systems or components of the system can be received. Based on the received behavior data, a plurality of parameters can be estimated for the availability model. Next, individual confidence intervals can be determined for each of the parameters. Based on the individual distributions of the parameters, an overall confidence interval for the system availability can be determined. Further, according to one embodiment, based on the estimated availability and the parameter values of the model, control actions can be suggested for maximizing availability of the system.

Availability of a system can be defined as the fraction of time the system is providing service to its users. Limiting or steady state availability of a system is computed as the ratio of mean time to failure (MTTF) of the system to the sum of mean time to failure and mean time to repair (MTTR). It is the steady state availability that can be translated into other metrics such as downtime per year. The above definition for availability provides the point estimate of limiting availability. In critical applications, there should be a reasonable confidence in the estimated value of system availability. Therefore, it is important to also estimate the confidence intervals for availability.

The methods and systems for estimating online availability of a system will be explained in the context of flow charts and diagrams. It is understood that the flow charts and diagrams can be implemented in hardware, software, or a combination of hardware and software. Thus, the subject matter disclosed herein can include computer program products comprising computer-executable instructions embodied in computer-readable media for performing the steps illustrated in each of the flow charts or implementing the machines illustrated in each of the diagrams. In one embodiment, the hardware and software for estimating online availability of a system is located in a computer connected to sub-systems or components of the system.

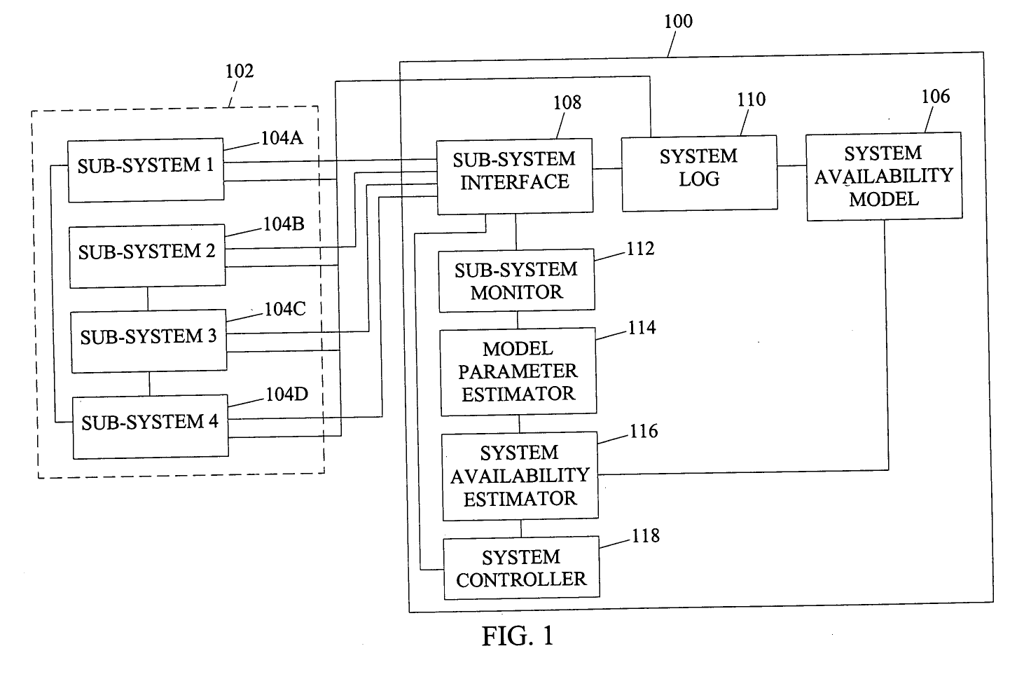

FIG. 1 is a schematic diagram of an online availability estimator 100 according to one embodiment. Online availability estimator 100 can be operably connected to a system 102 for which online availability is estimated. According to one embodiment, system 102 is an air traffic control system. Alternatively, system 102 can be a missile tracking system, a missile defense system, a radar signal processing system, an interceptor system, a surveillance and early warning system, or another suitable system that may have critical application. Alternatively, availability estimator 100 can be applied to a credit card authorization system, an online brokerage system, or a transaction processing system.

System 102 can include a plurality of sub-systems 104A-104D operably connected to availability estimator 100. Sub-systems 104A-104D can be components required for the availability and/or operation of system 102. For example, a missile defense system can consist of several required sub-systems, such as radar, interceptor, early warning systems, and space-based infrared systems, which are controlled by a command and control system. Other exemplary sub-systems include input/output (I/O) devices, hard disks, memory, and CPUs. In addition, sub-systems 104A-104D can be devices for indicating the status of other components of system 102. Sub-systems 104A-104D can be operably connected to and/or dependent on one another or disparate components.

Availability estimator 100 can be in communication with sub-systems 104A-104D for receiving data indicating the behavior of sub-systems 104A-104D and/or system 102 or its components. According to one embodiment, availability estimator 100 can receive the behavior data online, i.e., during operation of system 102. Based on the received behavior data, availability estimator 100 can determine the overall availability of system 102. In addition, availability estimator 100 can issue control commands to sub-systems 104A-104D, system 102, and/or other components of system 102 for maximizing the availability of system 102 and sub-systems 104A-104D.

### System Availability Model

According to one embodiment, a method for estimating online availability of a system includes providing an availability model of the system. Availability estimator 100 can include and manage a system availability model 106. The purpose of system availability model 106 is capturing the behavior of system 102 with respect to the interaction and dependencies between sub-systems 104A-104D or other components of system 102, and their various modes of failure and repair.

System availability modeling can be implemented with discrete-event simulation or analytic models. Alternatively, a hybrid approach of combining both the simulation and analytic methods can also be implemented.

Analytic modeling includes non-state space modeling and state space modeling. Non-state space-based availability models assume that all sub-systems have statistically independent failures and repairs. Reliability block diagrams (RBD) and fault trees are two non-state space modeling techniques that can be utilized to evaluate system availability.

According to one embodiment, availability model 106 can be based on the reliability block diagram modeling technique. The reliability blocks can be connected in series/parallel or k-out-of-n combinations based on operational dependencies. In this embodiment, availability model 106 can comprise a plurality of reliability blocks arranged in a reliability block diagram configuration. Each block of the reliability block diagram can correspond to one of sub-systems 104A-104D. Additionally, information regarding reliability block diagrams can be found in the publication “A Realistic Reliability and Availability Prediction Methodology for Power Supply Systems”, by G. Kervarrec and D. Marquet, 24th Annual International Telecommunications Energy Conference, INTELEC, pp. 279-286 (October 2002), the contents of which are incorporated herein by reference.

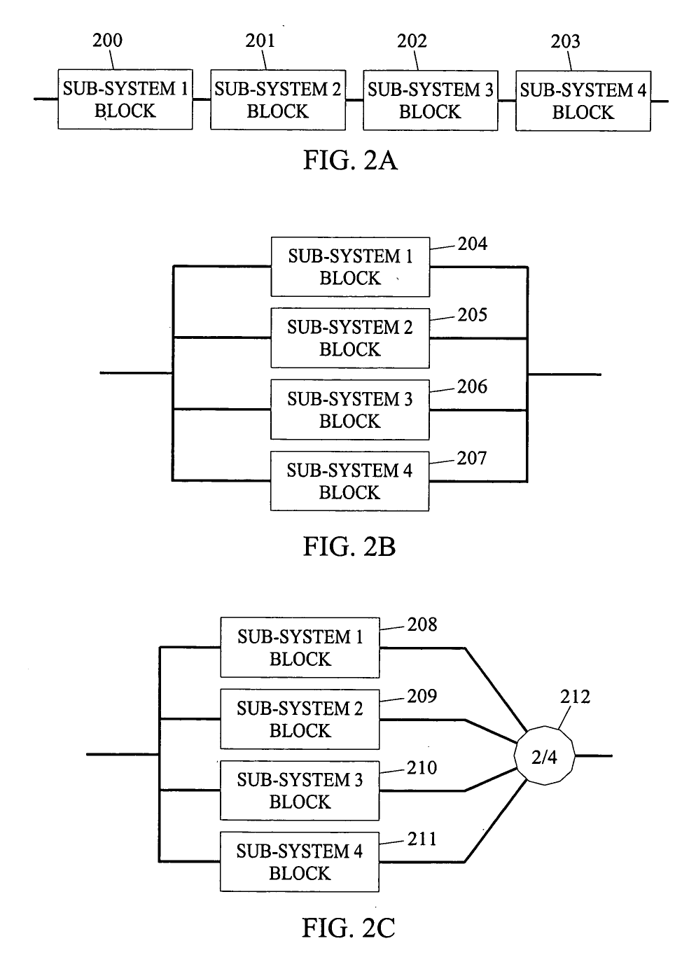

FIGS. 2A-2C illustrate block diagrams of different exemplary reliability block diagrams representing different embodiments of system 102 shown in FIG. 1. Referring to FIG. 2A, each of sub-systems 104A-104D is represented as reliability blocks 200-203, respectively, connected in a series configuration. According to this embodiment of system 102, the operation of system 102 is dependent upon each of sub-systems 104A-104D. Therefore, each of reliability blocks 200-203 are connected in series because system 102 requires that each sub-system 104A-104D are operationally dependent. The failure of one of sub-systems 104A-104D can result in the failure of system 102.

Referring to FIG. 2B, each of sub-systems 104A-104D is represented as reliability blocks 204-207, respectively, connected in a parallel configuration. According to this embodiment of system 102, the operation of system 102 is not dependent upon each of sub-systems 104A-104D. The failure of any of sub-systems 104A-104D does not result in the failure of system 102 because the system can operate with at least one of sub-systems 104A-104D. Therefore, each of reliability blocks 200-203 is connected in parallel.

Referring to FIG. 2C, each of sub-systems 104A-104D is represented as reliability blocks 208-211, respectively, connected in a k-out-of-n combination. According to this embodiment of system 102, the operation of system 102 is dependent upon at least two of sub-systems 104A-104D. The failure of two or less of sub-systems 104A-104D does not result in the failure of system 102. Therefore, each of reliability blocks 200-203 are connected in parallel and to a 2/4 block indicating that at least two of sub-systems 104A-104D are required for the operation of system 102. Additionally, information regarding reliability block diagrams can be found in the book titled “Probability and Statistics with Reliability, Queuing and Computer Science Applications (2^{nd} Edition)” by Prof. Kishor S. Trivedi, John Wiley and Sons, New York, (2001),

According to another embodiment, availability model 106 can be based on the fault tree modeling technique. A fault tree is a graphical representation of the combination of events that can cause a failure of system 102. All of the basic events represented in the fault tree are mutually independent. In order to represent situations where one failure event propagates failures along multiple paths in the fault tree, fault trees can have repeated nodes. Availability estimator 100 can be operable to solve the fault tree. The following method types can be utilized to solve fault trees: (1) factoring/conditioning on the shared nodes; (2) sum of disjoint products (SDPs); and (3) binary decision diagrams (BDDs). Fault trees are contrasted with reliability block diagrams in that reliability block diagrams can evaluate the conditions when system 102 functions, and fault trees can evaluate conditions when a system 102 fails. A more detailed example of a fault tree model is described hereinbelow in the section titled Exemplary Process for Online Availability Estimation. Additionally, information regarding fault trees can be found in the book titled “Probability and Statistics with Reliability, Queuing and Computer Science Applications (2^{nd} Edition)” by Prof. Kishor S. Trivedi, John Wiley and Sons, New York, (2001).

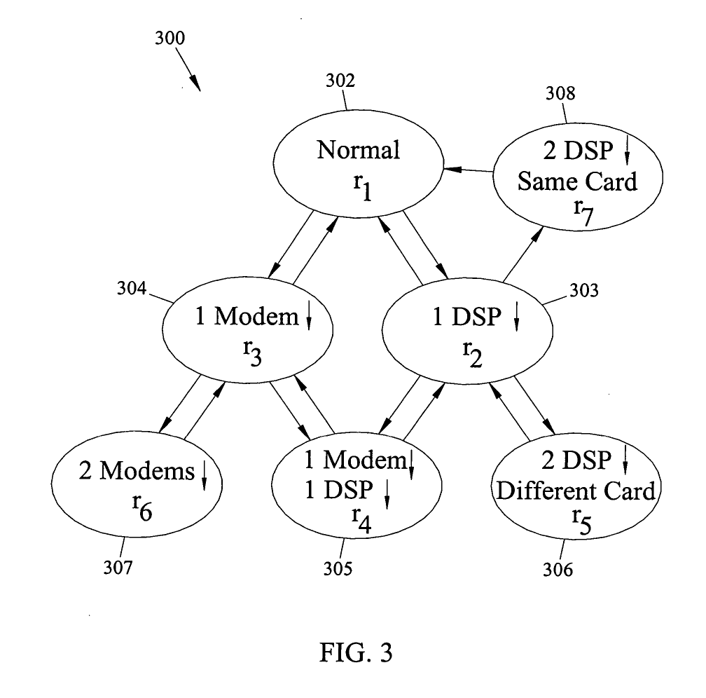

State space models include Markov chains, stochastic reward nets, semi-Markov processes, and a Markov regenerative processes. According to one embodiment, availability model 106 can include a homogenous continuous time Markov chain (CTMC) for representing system 102. FIG. 3 illustrates an exemplary CTMC, generally designated 300, for representing an Internet gateway according to one embodiment. The Internet gateway includes a pool of N=6 modems and each modem has N_{d}=8 DSP chips. Each state (designated 302-308) of CTMC 300 can represent a specific condition of the Internet gateway. The failure and repair (replacement) rates of each modem are λ and μ, respectively. Failure rate of a DSP chip is λ_{d} and DSP chip failures are repaired only by replacing the whole modem. Failure of a single modem brings down the system capacity but the system is considered “up”, until at least one of the modems is working. Additional information regarding CTMC may be found in the publication titled “Availability Analysis of Load Sharing Systems”, by Chun Kin Chan, Annual Reliability and Maintainability Symposium, pp. 551-555 (January 2003), the contents of which are incorporated herein by reference.

In homogenous CTMCs, transitions from one state to another occur after a time that is exponentially distributed. Arcs representing transition from one state to another are labeled by the time independent rate corresponding to the exponentially distributed time of the transition. Based on the condition of the system in any state, “up” and “down” states are marked. The limiting availability of the system is the steady state probability of the system to be in one of those “up” states. Additionally, information regarding CTMCs can be found in the book titled “Probability and Statistics with Reliability, Queuing and Computer Science Applications (2^{nd} Edition)” by Prof. Kishor S. Trivedi, John Wiley and Sons, New York, (2001), the contens of which are incorporated herein by reference. Solutions to large and complex Markov chains can be solved utilizing a suitable software package such as Sharpe available at Dr. Kishor S. Trivedi's website at URL: http://www.ee.duke.edu/˜kst and made available by Dr. Kishor S. Trivedi, Durham, N.C., U.S.A.

According to one embodiment, availability model 106 can include a Stochasic Petri Net (SPN) for representing system 102. A stochastic reward net (SRN) is an extension of the SPN with notions of reward functions and several marking dependent features that can simplify the graphical representation of the model. A large variety of reward-based measures can be calculated with the help of SRN. SRN-based availability models are described in further detail herein. To obtain the steady state availability, reward function is so defined that a reward rate of 1 is assigned to markings corresponding to the system being in “up” state and 0 otherwise. Additional information regarding SPNs can be found in the book titled “Probability and Statistics with Reliability, Queuing and Computer Science Applications (2^{nd} Edition)” by Prof. Kishor S. Trivedi, John Wiley and Sons, New York, (2001), the contents of which are incorporated herein by reference.

### Monitoring System Behavior Data

Estimating online availability of a system also includes monitoring and receiving behavior data for the system. The behavior data can include information regarding the failure times and repair times of the system or components 104A-104D, for each modes of failure and each mode of repair of sub-systems 104A-104D, and various other behavior data with respect to system 102. Availability estimator 100 can include a sub-system interface 108 having multiple ports for communicating with sub-systems 106. In addition, availability estimator 100 can use a system log 110 that has stored the behavior data of the components/subsystems.

Availability estimator 100 can include a sub-system monitor 112 for monitoring the behavior data of sub-systems 106. Monitoring of sub-system 106 can be implemented via any one or combination of the following processes: continuously monitoring data in system log 110, actively probing any sub-system 106 or component of system 102 for its status, performing health checks, monitoring heart beat messages from system 102, or any combination thereof. System log 110 may be connected to sub-systems 104A-104D of system 102 for continuously inspecting system log and sending sub-system log messages to system log 110.

Monitor 112 can inspect the data of log 110 to assess the operational status of sub-systems 104A-104D. Monitor 112 can continuously monitor the logged data from components of sub-systems 104A-104D that report specific error messages. Alternatively, monitor 112 can periodically poll sub-systems 104A-104D for behavior data. The behavior data can also indicate sub-system status such as network status and system resource levels. In addition, availability estimator 100 can perform test transactions and check their output for correctness, and exit status. In addition, execution time of test transactions can be monitored to determine the status of various other components.

System or sub-system failures can be attributed to hardware and/or software faults. Error log messages due to hardware faults can be broadly classified as: (1) central processing unit (CPU) related errors, caused by cache parity faults, bit flips in registers or caches, bus errors, etc.; (2) memory faults such as ECC errors, which when not corrected can cause the system to give out log messages; (3) disk faults, such as disk failures and bad sectors; and (4) various miscellaneous hardware failures such as fan failures and power supply failures.

For assessing system health, system health monitor 112 can actively probe system 102. Probing can be implemented by pinging the sub-system or system component under consideration.

As another example of system health monitoring, in industrial robotic systems, error-logging mechanisms can include error codes that particularly point out a sub-system or action that failed. For example, in a robotic system, the system can generate specific error messages for a large class of failures at all locations in the system (e.g., motors, gripper, and force torque sensor on the robot and the storage and processing sub-systems of the controller). The robot can be connected to its controller through either a wired or wireless communication link. Active probing can be implemented to monitor the health of the communication link for detecting system health concerns.

The log messages at logging servers of a critical system that may be remote from the system can be inspected to retrieve behavior data. One example of such a critical system is an air traffic control system which typically maintains elaborate redundancies. These redundancies can range from having more than one command station placed apart geographically to redundant software and hardware in various stand-by schemes at each of these locations. Redundant networks can connect these separate command locations. Elaborate logging of every transaction can be carried out at the log servers. These log messages can be continuously inspected.

### Parameter Estimation and Individual Confidence Intervals

Estimating online availability of a system can include estimating system parameters based on system behavior data and determining confidence intervals for each of the parameters. Availability estimator 100 can include a model parameter estimator 114 for estimating system parameters based on system behavior data. In addition, model parameter estimator 114 can determine individual confidence intervals for each of the parameters.

According to one embodiment, model parameter estimator 114 can estimate the parameters of availability model 102 from the collected data by using methods of statistical inference. Parameter estimator 114 can perform goodness of fit tests upon the failure and repair data of each sub-systems 104A-104D. The goodness of fit tests can include a Kolmogorov-Smirnov test and probability plot. Next, the model parameters of the closely fitting distribution can be calculated. The point estimate of limiting availability for any of components or sub-systems 104A-104D can be calculated as the ratio of mean time to failure and sum of mean time to failure and mean time to repair. Depending on the distribution of time to failure and time to repair, confidence intervals can be computed for the limiting availability of each of sub-systems 104A-104D as described in further detail below.

### Overall Confidence Interval for the System

Estimating online availability of a system also includes determining an overall confidence interval for the system availability. This determination can be based on the distributions of the parameters of availiability model. Availability estimator 100 can include a system availability estimator (Point and confidence interval) 116 for determining the system availability and an overall confidence interval for the availability of the system based on the individual confidence intervals for sub-systems 104A-104D. As noted above, the individual confidence intervals can be determined by model parameter estimator 114. The system availability and its confidence interval estimation may both utilize system availability model 106.

The estimators of each of the input parameters in system availability model 106 can be random variables and have their own distributions. The estimators can be determined by utilizing maximum likelihood estimates and a Fisher Information matrix. Thus, the point estimates have some associated uncertainty which can be accounted for in the confidence intervals. The uncertainty expressed in the distributions of the different parameters of system availability model 106 can be propagated through model 106 to get the uncertainty or the confidence interval of the overall system availability. According to one embodiment, a Monte Carlo approach can be utilized for uncertainty analysis. The Monte Carlo approach is applicable to state space-based and non-state space-based models. In this embodiment, system availability model 106 can be seen as a function of input parameters. For example, if Λ={λᵢ, i=1, 2, . . . , n} is the set of input parameters, the overall availability A can be calculated through a Monte Carlo method as follows:
(1) draw samples Λ^{(j)} from f(Λ), where j=1, 2, . . . , J, wherein J is the total number of iterations;
(2) compute A^{(j)}=g(Λ^{(j)}); and
(3) summarize A^{j)}.
   In the case that λᵢs are mutually independent and so the joint probability density function f(Λ) can be broken down into product of marginal density functions. In the independent case, samples can be independently drawn from each marginal density. Thus, drawing enough numbers of samples and evaluating the system availability at each of these parameter values, confidence intervals for the overall system availability can be determined.

### System Control

Sub-systems can be controlled by an availability estimator according to one embodiment for maximizing the availability of the system. According to one embodiment, availability estimator 100 can include a system controller 118 for controlling sub-systems 104A-104D.

Control action can be adaptively triggered based on online estimation. When the availability of system 102 falls below a certain threshold, alternate system models can be evaluated at the values of the estimated parameters. The system can then be reconfigured to the configuration that has the maximum availability at those estimated parameter values.

According to one embodiment, reconfiguration is applicable to both the hardware and software components. The various replication schemes (i.e., cold, warm, and hot) to ensure fault tolerance in software and hardware will have their own overhead-availability tradeoffs. The configuration for which the system model gives the maximum availability at those parameter values can be selected. The sub-systems can be controlled based on the selection.

According to one embodiment, preventive maintenance can be utilized for increasing system availability when aging of components occurs. The optimal preventive maintenance interval can be obtained in many cases as a function of the parameter values of the availability model. The availability can then be optimized with respect to the preventive maintenance trigger interval. Preventive maintenance may be for hardware or software (in the latter case, it is referred to as software rejuvenation).

### Exemplary Online Availability Estimator

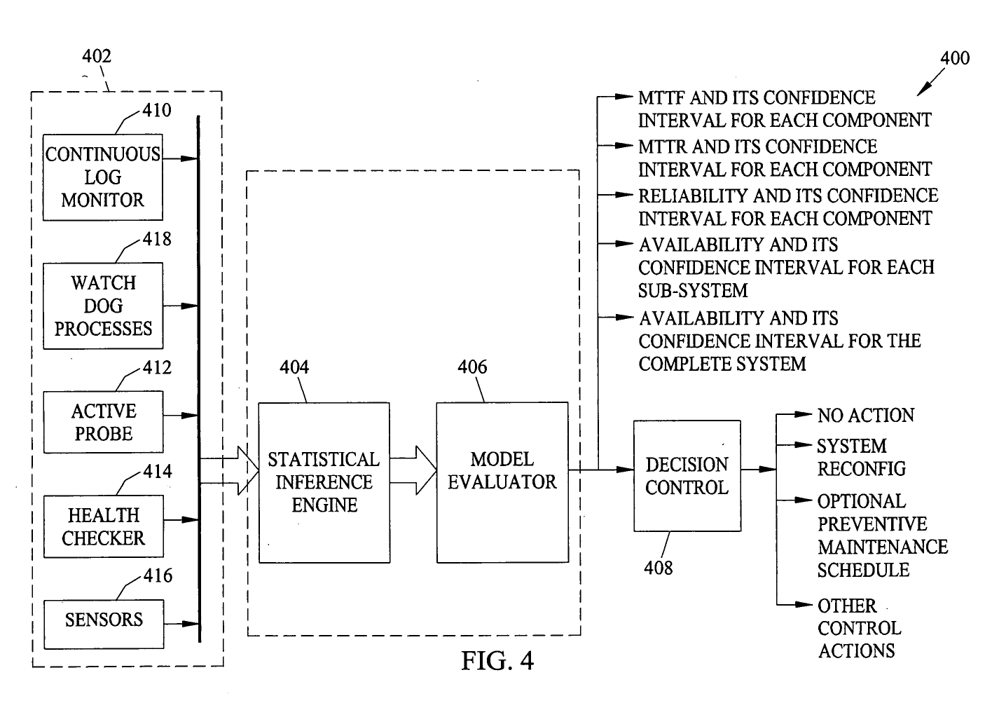

FIG. 4 is a schematic diagram of another exemplary online availability estimator, generally designated 400, according to one embodiment. Availability estimator 400 can include a plurality of monitoring tools 402 for receiving and retrieving behavior data from a monitored system (not shown). Availability estimator 400 can also include a statistical inference engine 404 and a model evaluator 406 for computing system availability data as per step (2) of the above Monte Carlo procedure. In addition, availability estimator 400 can include a decision control module 408 for controlling the sub-systems of the monitored system (not shown).

Monitoring tools 402 can include components for inspecting the monitored system and application log/error messages continuously for components providing specific error messages such as I/O devices, hard disk, memory, and CPU. Monitoring tools 402 can include a continuous log monitor 410 for continuously inspecting log/error messages. An active probe 412 can actively poll various sub-systems to determine status of the sub-system or other components of the monitored system. A health checker 414 can check the overall health of the monitored system. Sensors 416 can detect failures such as fan failures. Watch dog processes 418 can listen to heartbeat messages from subsystems/components.

Referring to FIG. 4, statistical inference engine 404 can estimate parameters of a system availability model by using methods of statistical inference. First, statistical inference engine 404 can perform goodness of fit tests (e.g., Kolmogorov-Smirnov test and probability plot) upon the failure and repair data of each monitored sub-system or component. Next, the parameters of the closely fitting distribution can be calculated. The point estimate of limiting availability for any sub-system or component can be calculated as the ratio of mean time to failure and sum of mean time to failure and mean time to repair. Depending upon the distribution of time to failure and time to repair, exact or approximate confidence intervals can be calculated for the limiting availability of each sub-system. According to one or more embodiments, model evaluator 406 can output MTTF and its confidence interval for each component; MTTR and its confidence interval for each component; reliability and its confidence interval for each component; availability and its confidence interval for each component or sub-system; and availability and its confidence interval for the complete system.

According to one embodiment, model evaluator 406 can utilize the SHARPE software for solving the system availability model online. The SHARPE software can obtain the point estimate of the overall system availability. Confidence intervals for the overall system availability can be calculated online by utilizing a Monte Carlo approach.

Referring to FIG. 4, decision control module 408 can control the sub-systems based on the overall system availability. For system availability below a predetermined threshold value and any set of parameter values, control module 408 can calculate the availability of the system in several different configurations. Next, the system can be reconfigured to the configuration determined to have the maximum availability. In addition, using the parametric or non-parametric approach, an optimal repair/replacement schedule can be obtained for the sub-systems and output to the sub-systems. Further, other types of suitable control actions can be ordered or suggested.

### Exemplary Process for Online Availability Estimation

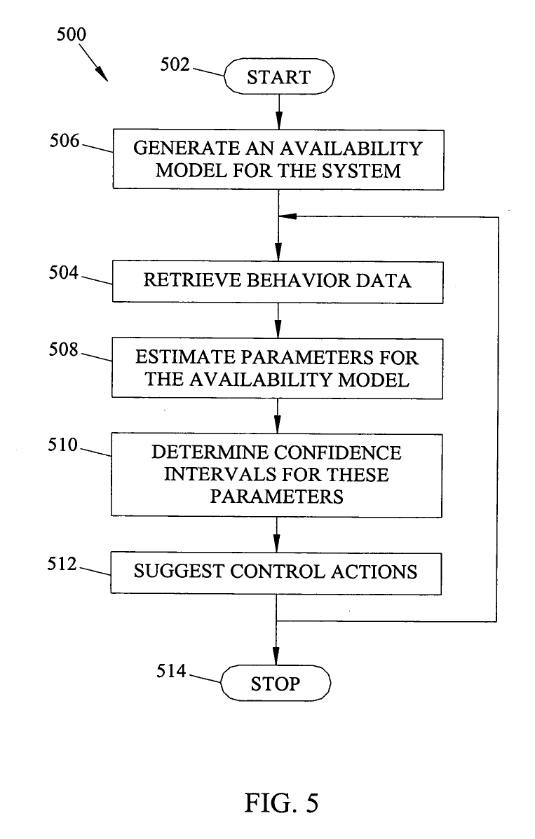

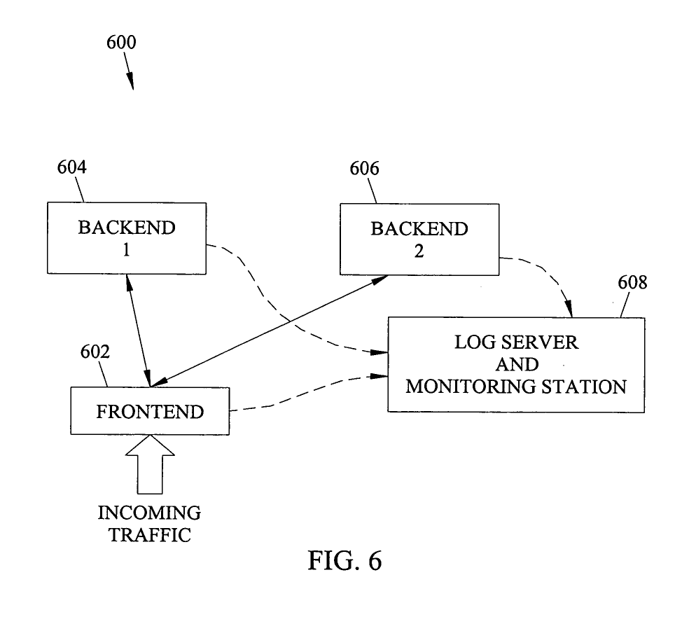

FIG. 5 is a flow chart, generally designated 500, illustrating an exemplary process for online availability estimation and control of a system. For the purposes of this exemplary process, FIG. 6 illustrates a schematic diagram of a transaction processing system 600, which is made reference to for illustrative purposes with respect to FIG. 5. In particular, the flow chart of FIG. 5 illustrates a process for availability estimation and control of system 600. FIG. 5 can also be applied similarly to the other monitored systems described herein for the purpose of online estimation and control. The steps illustrated in FIG. 5 may be performed by availability estimator 100 illustrated in FIG. 1.

According to one embodiment, the system monitored by the process of FIG. 6 is a transaction processing system. For the purposes of this exemplary process, a schematic diagram of a transaction processing system 600 is illustrated in FIG. 6. Referring to FIG. 6, system 600 can include a frontend module 602 for receiving incoming transaction traffic. Frontend module 602 can then forward the incoming traffic to backend module 1 604 and backend module 2 606 based on a load balancing scheme. Backend modules 604 and 606 can perform transaction processing on the received transaction traffic and return response information to frontend module 602. In addition, one of backend modules 602 and 604 can handle the transaction processing duties of both modules 602 and 604 on the failure of the other module. Modules 602, 604, and 606 can forward log messages, probe responses, and heartbeat messages to a log server and monitoring station 608.

Referring back again to FIG. 5, process 500 can begin at step 502. At step 504, an availability estimator (such as availability estimator 100 shown in FIG. 1) can retrieve the information stored in station 608 (FIG. 6). The retrieved information can indicate the behavior of system 600. The stored information can also be periodically forwarded to the availability estimator. In this example, the retrieved information can be indications of a failed or repaired/replaced hard disk drive, memory (e.g. ECC errors), CPU, system bus, fans, etc. Station 608 can actively probe modules 602, 604, and 606 (FIG. 6) for their status of various components, or modules 602, 604, and 606 can send heartbeat signals to station 608. Station 608 can also continuously inspect log messages from modules 602, 604, and 606 to obtain the failure and repair times of various components/subsystems. An availability model of system 600 (FIG. 6) based on the conditions for system 600 to be available can be constructed offline. At step 506, the availability model of system 600 (FIG. 6) based on the conditions for system 600 to be available is constructed.

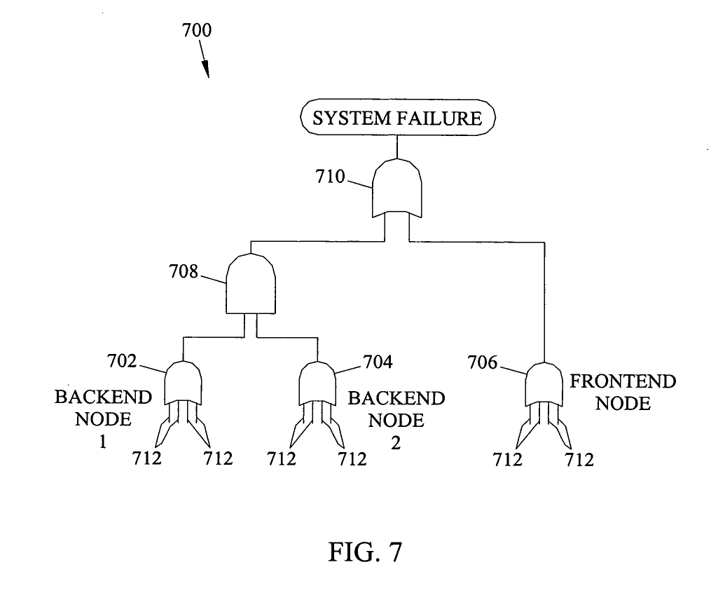

Referring to FIG. 7, a schematic diagram illustrating an exemplary availability model, generally designated 700, for system 600 shown in FIG. 6 is shown. Availability model 700 can be maintained in availability estimator 100 (FIG. 1) as system availability model 106 (FIG. 1). Referring to FIG. 7, availability model 700 is a fault tree including a plurality of nodes 702, 704, 706, 708, and 710. Nodes 702, 704, and 706 correspond to backend module 1 604 (FIG. 6), backend module 2 606 (FIG. 6), and frontend module 602 (FIG. 6), respectively.

The failure of system 600 (FIG. 6) can result when frontend module 602 fails or both backend modules 604 and 606 fail. Referring to FIG. 7, model 700 can model these failure scenarios for system 600 (FIG. 6). Each of nodes 702, 704, and 706 can be logic “OR” blocks and include a plurality of inputs 712 for receiving an unavailability of one of the components of modules 602, 604, and 606 (FIG. 6), respectively. An indication of unavailability on one of inputs 712 of nodes 702 or 704 is propagated to the input of node 708. Node 708 can be a logic “AND” block for propagating the unavailability of both backend modules 604 and 606 (FIG. 6) to node 710 only on the unavailability of both modules 604 and 606. An indication of unavailability on one of inputs 712 of node 706 is propagated to the input of node 710. Node 710 is a logic “OR” block for outputting a system failure indication only on the input of a failure indication from either node 706 or node 708. Therefore, system failure is output by model 700 only when frontend module 602 fails or both backend modules 604 and 606 fail.

Referring now to FIG. 5, at step 508, the availability estimator (such as availability estimator 100 shown in FIG. 1) can estimate parameters for the availability model based on the retrieved data from modules 602, 604, and 606 (FIG. 6). For example, the time to failure (TTF) and time to repair (TTR) can be calculated at observation i for each of modules 602, 604, and 606 with the following equations:
TTF[i]=time_component_went_up[i]−time_component_went_down[i]
TTR[i]=time_component_went−down[i−1]−time_component_came_up[i]
The unavailability of each of modules 602, 604, and 606 can be calculated as the ratio of mean time to repair and sum of mean time to repair and mean time to failure. The unavailability of each of modules 602, 604, and 606 serves as input to fault tree model 700 and the point estimate of overall system availability can be calculated by evaluating fault tree model 700. The time to failure and time to repair data can be fitted to some known distributions (e.g., Weibull distribution, lognormal distribution, and exponential distribution) and the parameters for the best fitting distribution can be calculated. Utilizing exact or approximate methods, confidence intervals for these parameters can be determined (step 510). Alternatively, an exact method can be used to determine the confidence intervals.

Referring to FIG. 5, overall confidence intervals for system 600 (FIG. 6) can be determined. In this embodiment, the Monte Carlo approach as described above can be utilized to determine the overall confidence intervals. In this example, model 700 (FIG. 7) is fixed and reconfigurations cannot be implemented. However, based on the estimated availability, its confidence intervals and inferred parameter values, the availability estimator can recommend or suggest control actions for optimizing system availability (step 512). For example, an optimal preventive maintenance schedule for modules 602, 604, and 606 can be derived based on the estimated parameter values. Steps 508, 510, and 512 can be continuously run during online implementation. The step of generating an availability model for the system (step 506) can be implemented offline. The process can stop at step 514. In alternative embodiments, model 700 can be reconfigured for optimizing availability.

It will be understood that various details of the subject matter disclosed herein may be changed without departing from the scope of the subject. Furthermore, the foregoing description is for the purpose of illustration only, and not for the purpose of limitation.

What is claimed is:

1. A method for estimating online availability of a system, the method comprising:
(a) providing an availability model of a system;
(b) receiving behavior data of the system;
(c) estimating a plurality of parameters for the availability model based on the behavior data;
(d) determining individual confidence intervals for each of the parameters;
(e) determining an overall confidence interval for the system based on individual distributions of the estimated parameters; and
(f) determining control actions based on the estimated overall availability or inferred parameter values.

2. The method according to claim 1, wherein the availability model is a discrete-event model.

3. The method according to claim 1, wherein the availability model is an analytical model.

4. The method according to claim 3, wherein the analytical model is a non-state space model.

5. The method according to claim 4, wherein the non-state space model of the system comprises a plurality of blocks of a reliability block diagram, wherein each of the blocks correspond to one of plurality of sub-systems of the system.

6. The method according to claim 5, comprising connecting the blocks in series, parallel, or k-out-of-n configuration.

7. The method according to claim 4, wherein the non-state space model of the system comprises a fault tree corresponding to events that cause a failure of the system.

8. The method according to claim 3, wherein the analytical model is a state space model.

9. The method according to claim 3, wherein the analytical model is a Markov chain.

10. The method according to claim 9, wherein the Markov chain comprises a plurality of states that each represents a specific condition of the system.

11. The method according to claim 10, wherein the Markov chain comprises a plurality of arcs representing transitions between the states, wherein the arcs are labeled by the time independent rate corresponding to the exponentially distributed time.

12. The method according to claim 3, wherein the analytical model is a stochastic reward net.

13. The method according to claim 12, comprising providing a stochastic petri net (SRN) for generating state space.

14. The method according to claim 3, wherein the analytical model is a semi-Markov process.

15. The method according to claim 3, wherein the analytical model is a Markov Regenerative process.

16. The method according to claim 3, wherein the analytical model is a hierarchical model or a combination of a state space and non-state space model.

17. The method according to claim 1, wherein receiving behavior data comprises monitoring a log for the system.

18. The method according to claim 17, wherein the log comprises system error records.

19. The method according to claim 18, wherein the system error records comprise error records selected from the group consisting of CPU errors, memory errors, disk errors, and fan failures.

20. The method according to claim 1, wherein receiving behavior data comprises probing sub-systems of the system.

21. The method according to claim 20, wherein probing sub-systems comprises determining availability of system resources.

22. The method according to claim 20, wherein probing sub-systems comprises monitoring exit status of CPU registers for detecting errors in the CPU registers.

23. The method according to claim 1, wherein receiving behavior data comprises monitoring system resource levels.

24. The method according to claim 1, wherein receiving behavior data comprises monitoring heart beat messages from components in the system.

25. The method according to claim 1, wherein receiving behavior data comprises receiving the behavior data continuously.

26. The method according to claim 1, wherein estimating a plurality of parameters comprises performing a goodness of fit test against predetermined distributions for determining the distribution of the behavior data for the components of the system.

27. The method according to claim 26, wherein the goodness of fit test is an analytical goodness of fit test.

28. The method according to claim 27, wherein the analytical goodness of fit test is a Kolmogorov-Smirnov test.

29. The method according to claim 26, wherein the goodness of fit test is a graphical goodness of fit test.

30. The method according to claim 29, wherein the graphical goodness of fit test is a probability plot.

31. The method according to claim 26, wherein the distribution of the behavior data is a distribution selected from the group consisting of exponential, Weibull distribution, and lognormal distribution.

32. The method according to claim 31, wherein the behavior data comprises time to failure data corresponding to a sub-system of the system, and wherein estimating the plurality of parameters comprises fitting the Weibull distribution to the time to failure data.

33. The method according to claim 31, wherein the behavior data comprises time to repair data corresponding to a sub-system of the system, and wherein estimating the plurality of parameters comprises fitting distribution to the time to repair data.

34. The method according to claim 1, wherein estimating a plurality of parameters comprises determining point estimates of the parameters.

35. The method according to claim 34, wherein determining point estimates of the parameters is based on maximum likelihood estimation.

36. The method according to claim 1, wherein determining individual confidence intervals comprises utilizing a random variable with a predetermined distribution.

37. The method according to claim 36, wherein the predetermined distribution is a function of the random sample and a parameter of interest.

38. The method according to claim 1, wherein determining individual confidence intervals comprises utilizing maximum likelihood estimates and a Fisher Information matrix.

39. The method according to claim 1, wherein determining the overall confidence interval comprises applying a Monte Carlo approach for uncertainty analysis.

40. The method according to claim 39, wherein the parameters comprise Λ={λᵢ, i=1, 2, . . . , n}, and an overall availability of the system is a function g such that A=g(λ₁, A₂, . . . , λₙ}=g{Λ}.

41. The method according to claim 40, comprising:
(a) drawing samples Λ^{(j)} from f(Λ), where j=1, 2, . . . , J and J is the total number of iterations;
(b) computing A^{(j)}=g(Λ^{(j)}); and
(c) summarizing A^{(j)}.

42. The method according to claim 1, comprising determining control actions based on the estimated model parameters values for maximizing availability of the system.

43. The method according to claim 1, comprising:
(a) constructing a model of a preventive system maintenance for the system or its components and sub-systems;
(b) obtaining an expression of system availability;
(c) optimizing availability with respect to a preventive maintenance trigger interval; and
(d) determining alternate configurations after evaluating the system availability for various configurations at any set of inferred parameter values.

44. An online availability estimator for estimating availability of a system, comprising:
(a) an availability model of a system;
(b) a monitor for receiving behavior data of the system;
(c) a parameter estimator for estimating a plurality of parameters for the availability model based on the behavior data and for determining individual confidence intervals for each of the parameters; and
(d) a system availability estimator for determining an overall confidence interval for the system based on the individual confidence intervals.

45. The availability estimator according to claim 44, wherein the availability model is a discrete-event model.

46. The availability estimator according to claim 44, wherein the availability model is an analytical model.

47. The availability estimator according to claim 46, wherein the analytical model is a non-state space model.

48. The availability estimator according to claim 47, wherein the non-state space model of the system comprises a plurality of blocks of a reliability block diagram, wherein each of the blocks correspond to one of plurality of sub-systems of the system.

49. The availability estimator according to claim 48, comprising connecting the blocks in series.

50. The availability estimator according to claim 48, comprising connecting the blocks in parallel.

51. The availability estimator according to claim 47, wherein the non-state space model of the system comprises a fault tree corresponding to events that cause a failure of the system.

52. The availability estimator according to claim 46, wherein the analytical model is a state space model.

53. The availability estimator according to claim 46, wherein the analytical model is a Markov chain.

54. The availability estimator according to claim 53, wherein the Markov chain comprises a plurality of states that each represents a specific condition of the system.

55. The availability estimator according to claim 54, wherein the Markov chain comprises a plurality of arcs representing transitions between the states, wherein the arcs are labeled by the time independent rate corresponding to the exponentially distributed time.

56. The availability estimator according to claim 46, wherein the analytical model is a stochastic reward net.

57. The availability estimator according to claim 56, wherein the parameter estimator is operable to provide a stochastic petri net (SRN) for generating state space.

58. The availability estimator according to claim 46, wherein the analytical model is a semi Markov process.

59. The availability estimator according to claim 46, wherein the analytical model is a Markov Regenerative process.

60. The availability estimator according to claim 44, wherein the monitor for receiving behavior data of the system is operable to monitor a log for the system.

61. The availability estimator according to claim 60, wherein the log comprises system error records.

62. The availability estimator according to claim 61, wherein the system error records comprise error records selected from the group consisting of CPU errors, memory errors, disk errors, and fan failures.

63. The availability estimator according to claim 44, wherein the monitor is operable to probe sub-systems of the system.

64. The availability estimator according to claim 44, wherein the monitor is operable to determine availability of system resources.

65. The availability estimator according to claim 44, wherein the monitor is operable to monitor exit status of CPU registers for detecting errors in the CPU registers.

66. The availability estimator according to claim 44, wherein the monitor is operable to monitor heart beat messages of the system.

67. The availability estimator according to claim 44, wherein the monitor is operable to monitor the behavior data continuously.

68. The availability estimator according to claim 44, wherein the parameter estimator is operable to perform a goodness of fit test against predetermined distributions for determining the distribution of the behavior data of the system.

69. The availability estimator according to claim 68, wherein the goodness of fit test is an analytical goodness of fit test.

70. The availability estimator according to claim 68, wherein the analytical goodness of fit test is a Kolmogorov-Smirnov test.

71. The availability estimator according to claim 68, wherein the goodness of fit test is a graphical goodness of fit test.

72. The availability estimator according to claim 71, wherein the graphical goodness of fit test is a probability plot.

73. The availability estimator according to claim 71, wherein the distribution of the behavior data is a distribution selected from the group consisting of exponential, Weibull distribution, and lognormal distribution.

74. The availability estimator according to claim 73, wherein the behavior data comprises time to failure data corresponding to a sub-system of the system, and wherein the parameter estimator is operable to fit the Weibull distribution to the time to failure data.

75. The availability estimator according to claim 71, wherein the behavior data comprises time to repair data corresponding to a sub-system of the system, and wherein the parameter estimator is operable to fit the lognormal distribution to the time to repair data.

76. The availability estimator according to claim 44, wherein the parameter estimator is operable to determine point estimates of the parameters.

77. The availability estimator according to claim 76, wherein the parameter estimator determines point estimates of the parameters based on maximum likelihood estimation.

78. The availability estimator according to claim 44, wherein the system availability estimator is operable to determine individual confidence intervals by utilizing a random variable with a predetermined distribution.

79. The availability estimator according to claim 78, wherein the predetermined distribution is a function of the random sample and a parameter of interest.

80. The availability estimator according to claim 44, wherein the system availability estimator is operable to determine the overall confidence interval by applying a Monte Carlo approach for uncertainty analysis.

81. The availability estimator according to claim 80, wherein the parameters comprise Λ={λᵢ, i=1, 2, . . . , n}, and an overall availability of the system is a function g such that A=g(λ₁, λ₂, . . . , λₙ}=g{Λ}.

82. The availability estimator according to claim 81, wherein the system availability estimator is operable to:
(a) draw samples Λ^{(j)} from f(Λ), where j=1, 2, . . . , J and J is the total number of iterations;
(b) compute A^{(j)}=g(Λ^{(j)}); and
(c) summarize A^{(j)}.

83. The availability estimator according to claim 44, wherein the estimator controls sub-systems of the system based on the confidence intervals to maximize availability of the system.

84. The availability estimator according to claim 44, wherein the system availability estimator is operable to:
(a) construct a model of a preventive system maintenance for the system;
(b) obtain an expression of system availability; and
(c) optimize availability with respect to a preventive maintenance trigger interval.

85. A computer program product comprising computer-executable instructions embodied in a computer-readable medium for performing steps comprising:
(a) providing an availability model of a system;
(b) receiving behavior data of the system;
(c) estimating a plurality of parameters for the availability model based on the behavior data;
(d) determining individual confidence intervals for each of the parameters;
(e) determining an overall confidence interval for the system based on individual distributions of the estimated parameters; and
(f) determining control actions based on the estimated overall availability or inferred parameter values.

86. The computer program product according to claim 85, wherein the availability model is a discrete-event model.

87. The computer program product according to claim 85, wherein the availability model is an analytical model.

88. The computer program product according to claim 87, wherein the analytical model is a non-state space model.

89. The computer program product according to claim 88, wherein the non-state space model of the system comprises a plurality of blocks of a reliability block diagram, wherein each of the blocks correspond to one of plurality of sub-systems of the system.

90. The computer program product according to claim 89, comprising connecting the blocks in series, parallel, or k-out-of-n configuration.

91. The computer program product according to claim 88, wherein the non-state space model of the system comprises a fault tree corresponding to events that cause a failure of the system.

92. The computer program product according to claim 87, wherein the analytical model is a state space model.

93. The computer program product according to claim 87, wherein the analytical model is a Markov chain.

94. The computer program product according to claim 93, wherein the Markov chain comprises a plurality of states that each represents a specific condition of the system.

95. The computer program product according to claim 94, wherein the Markov chain comprises a plurality of arcs representing transitions between the states, wherein the arcs are labeled by the time independent rate corresponding to the exponentially distributed time.

96. The computer program product according to claim 87, wherein the analytical model is a stochastic reward net.

97. The computer program product according to claim 96, comprising providing a stochastic petri net (SRN) for generating state space.

98. The computer program product according to claim 87, wherein the analytical model is a semi-Markov process.

99. The computer program product according to claim 87, wherein the analytical model is a Markov Regenerative process.

100. The computer program product according to claim 87, wherein the analytical model is a hierarchical model or a combination of a state space and non-state space model.

101. The computer program product according to claim 85, wherein receiving behavior data comprises monitoring a log for the system.

102. The computer program product according to claim 101, wherein the log comprises system error records.

103. The computer program product according to claim 102, wherein the system error records comprise error records selected from the group consisting of CPU errors, memory errors, disk errors, and fan failures.

104. The computer program product according to claim 85, wherein receiving behavior data comprises probing sub-systems of the system.

105. The computer program product according to claim 104, wherein probing sub-systems comprises determining availability of system resources.

106. The computer program product according to claim 104, wherein probing sub-systems comprises monitoring exit status of CPU registers for detecting errors in the CPU registers.

107. The computer program product according to claim 85, wherein receiving behavior data comprises monitoring system resource levels.

108. The computer program product according to claim 85, wherein receiving behavior data comprises monitoring heart beat messages from components in the system.

109. The computer program product according to claim 85, wherein receiving behavior data comprises receiving the behavior data continuously.

110. The computer program product according to claim 85, wherein estimating a plurality of parameters comprises performing a goodness of fit test against predetermined distributions for determining the distribution of the behavior data for the components of the system.

111. The computer program product according to claim 110, wherein the goodness of fit test is an analytical goodness of fit test.

112. The computer program product according to claim 111, wherein the analytical goodness of fit test is a Kolmogorov-Smirnov test.

113. The computer program product according to claim 110, wherein the goodness of fit test is a graphical goodness of fit test.

114. The computer program product according to claim 113, wherein the graphical goodness of fit test is a probability plot.

115. The computer program product according to claim 109, wherein the distribution of the behavior data is a distribution selected from the group consisting of exponential, Weibull distribution, and lognormal distribution.

116. The computer program product according to claim 115, wherein the behavior data comprises time to failure data corresponding to a sub-system of the system, and wherein estimating the plurality of parameters comprises fitting the Weibull distribution to the time to failure data.

117. The computer program product according to claim 115, wherein the behavior data comprises time to repair data corresponding to a sub-system of the system, and wherein estimating the plurality of parameters comprises fitting distribution to the time to repair data.

118. The computer program product according to claim 85, wherein estimating a plurality of parameters comprises determining point estimates of the parameters.

119. The computer program product according to claim 118, wherein determining point estimates of the parameters is based on maximum likelihood estimation.

120. The computer program product according to claim 85, wherein determining individual confidence intervals comprises utilizing a random variable with a predetermined distribution.

121. The computer program product according to claim 120, wherein the predetermined distribution is a function of the random sample and a parameter of interest.

122. The computer program product according to claim 120, wherein determining individual confidence intervals comprises utilizing maximum likelihood estimates and a Fisher Information matrix.

123. The computer program product according to claim 85, wherein determining the overall confidence interval comprises applying a Monte Carlo approach for uncertainty analysis.

124. The computer program product according to claim 123, wherein the parameters comprise Λ={λᵢ, i=1, 2, . . . , n}, and an overall availability of the system is a function g such that A=g(λ₁, λ₂, . . . , λₙ)}=g{Λ}.

125. The computer program product according to claim 124, comprising:
(a) drawing samples Λ^{(j)} from p(Λ), where j=1, 2, . . . , J and J is the total number of iterations;
(b) computing A^{(j)}=g(Λ^{(j)}); and
(c) summarizing A^{(j)}.

126. The computer program product according to claim 86, comprising determining control actions based on the estimated model parameters values for maximizing availability of the system.

127. The computer program product according to claim 86, comprising:
(a) constructing a model of a preventive system maintenance for the system or its components and sub-systems;
(b) obtaining an expression of system availability;
(c) optimizing availability with respect to a preventive maintenance trigger interval; and
(d) determining alternate configurations after evaluating the system availability for various configurations at any set of inferred parameter values.
